(19) United States
(12) Patent Application Publication
(10) Pub. No.: US 2020/0042419 A1
(43) Pub. Date: Feb. 6, 2020

(54) SYSTEM AND METHOD FOR BENCHMARKING AI HARDWARE USING SYNTHETIC AI MODEL

(71) Applicant: Alibaba Group Holding Limited, George Town (KY)

(72) Inventors: Wei Wei, Hangzhou (CN); Lingjie Xu, Hangzhou (CN); Lingling Jin, Hangzhou (CN)

(73) Assignee: Alibaba Group Holding Limited, George Town (KY)

(21) Appl. No.: 16/051,078

(22) Filed: Jul. 31, 2018

(51) Int. Cl. G06F 11/34; G06N 3/04; G06F 9/50

(52) U.S. Cl. CPC G06F 11/3428; G06F 11/3447; G06F 9/5044; G06F 11/3414; G06N 3/04

(57) ABSTRACT

Embodiments described herein provide a system for facilitating efficient benchmarking of a piece of hardware for artificial intelligence (AI) models. During operation, the system determines a set of AI models that are representative of applications that run on the piece of hardware. The piece of hardware can be configured to process AI-related operations. The system can determine workloads of the set of AI models based on layer information associated with a respective layer of a respective AI model in the set of AI models and form a set of workload clusters from the determined workloads. The system then determines, based on the set of workload clusters, a synthetic AI model configured to generate a workload that represents statistical properties of the determined workload.

### BACKGROUND

### Field

This disclosure is generally related to the field of artificial intelligence (AI). More specifically, this disclosure is related to a system and method for generating a synthetic model that can benchmark AI hardware.

### Related Art

The exponential growth of AI applications has made them a popular medium for mission-critical systems, such as a real-time self-driving vehicle or a critical financial transaction. Such applications have brought with them an increasing demand for efficient AI processing. As a result, equipment vendors race to build larger and faster processors with versatile capabilities, such as graphics processing, to efficiently process AI-related applications. However, a graphics processor may not accommodate efficient processing of mission-critical data. The graphics processor can be limited by processing limitations and design complexity, to name a few factors.

As more AI features are being implemented in a variety of systems (e.g., automatic braking of a vehicle), AI processing capabilities are becoming progressively more important as a value proposition for system designers. Typically, extensive use of input devices (e.g., sensors, cameras, etc.) has led to generation of large quantities of data, which is often referred to as “big data,” that a system uses. The system can use large and complex models that can use AI models to infer decisions from the big data. However, the efficiency of execution of large models on big data depends on the computational capabilities, which may become a bottleneck for the system. To address this issue, the system can use AI hardware (e.g., an AI accelerator) capable of efficiently processing an AI model.

Typically, tensors are often used to represent data associated with AI systems, store internal representations of AI operations, and analyze and train AI models. To efficiently process tensors, some vendors have developed AI accelerators, such as tensor processing units (TPUs), which are processing units designed for handling tensor-based AI computations. For example, TPUs can be used for running AI models and may provide high throughput for low-precision mathematical operations.

While AI accelerators bring many desirable features to AI processing, some issues remain unsolved for benchmarking AI hardware for a variety of applications.

### SUMMARY

Embodiments described herein provide a system for facilitating efficient benchmarking of a piece of hardware for artificial intelligence (AI) models. During operation, the system determines a set of AI models that are representative of applications that run on the piece of hardware. The piece of hardware can be configured to process AI-related operations. The system can determine workloads of the set of AI models based on layer information associated with a respective layer of a respective AI model in the set of AI models and form a set of workload clusters from the determined workloads. The system then determines, based on the set of workload clusters, a synthetic AI model configured to generate a workload that represents statistical properties of the determined workload.

In a variation on this embodiment, the system obtains the layer information using a collection technique, wherein the collection technique includes one or more of: graphics processing unit (GPU) application programming interface (API) calls, TensorFlow calls, Caffe2, and MXNet.

In a variation on this embodiment, the system generates a set of computational layers such that a computational layer corresponds to a respective workload cluster in the set of workload clusters. The system then combines the set of computational layers to form the synthetic AI model.

In a further variation, the system determines a representative workload of the workload cluster and an input size that corresponds to the representative workload. The input size used in the layer of the synthetic AI model can generate the representative workload.

In a further variation, the process of determining the input size includes determining a set of input sizes corresponding to layers of the set of AI models, forming a set of input groups of the set of input sizes, and determining a representative input size for a respective input group in the set of input groups. The process also includes adjusting the representative input size for the representative workload to determine the input size.

In a further variation, the system adds a rectified linear unit (ReLU) layer and a normalization layer to a respective computational layer of the set of computational layers. The computational layer can then be a convolution layer.

In a further variation, forming the synthetic AI model can include adding a fully connected layer and a softmax layer to the synthetic AI model.

In a variation on this embodiment, the layer information includes number of filters, filter size, stride information, and padding information associated with the layer of the AI model.

In a variation on this embodiment, a respective workload of a workload cluster in the set of workload clusters incorporates an execution frequency of an AI model associated with the workload.

In a variation on this embodiment, the system evaluates performance of the piece of hardware by executing the synthetic AI model on the piece of hardware.

### BRIEF DESCRIPTION OF THE FIGURES

FIG. 1A illustrates an exemplary environment that facilitates generation of a synthetic AI model for benchmarking AI hardware, in accordance with an embodiment of the present application.

FIG. 1B illustrates an exemplary benchmarking system that generates a synthetic AI model for benchmarking AI hardware, in accordance with an embodiment of the present application.

FIG. 2A illustrates an exemplary clustering of the workloads of the layers of representative AI models based on respective workloads for generating a synthetic AI model, in accordance with an embodiment of the present application.

FIG. 2B illustrates an exemplary workload table for facilitating the clustering of the workloads, in accordance with an embodiment of the present application.

FIG. 2C illustrates an exemplary grouping of input sizes of the layers of representative AI models for generating a synthetic AI model, in accordance with an embodiment of the present application.

FIG. 3 illustrates an exemplary matching of clusters and corresponding input sizes, in accordance with an embodiment of the present application.

FIG. 4 illustrates an exemplary synthetic AI model representing a set of AI models corresponding to representative applications, in accordance with an embodiment of the present application.

FIG. 5A presents a flowchart illustrating a method of a benchmarking system collecting layer information of representative AI models, in accordance with an embodiment of the present application.

FIG. 5B presents a flowchart illustrating a method of a benchmarking system performing computation load analysis, in accordance with an embodiment of the present application.

FIG. 5C presents a flowchart illustrating a method of a benchmarking system clustering the layers of representative AI models based on respective workloads, in accordance with an embodiment of the present application.

FIG. 5D presents a flowchart illustrating a method of a benchmarking system grouping input sizes of the layers of representative AI models, in accordance with an embodiment of the present application.

FIG. 6A presents a flowchart illustrating a method of a benchmarking system matching clusters and corresponding input sizes, in accordance with an embodiment of the present application.

FIG. 6B presents a flowchart illustrating a method of a benchmarking system generating a synthetic AI model representing a set of AI models, in accordance with an embodiment of the present application.

FIG. 6C presents a flowchart illustrating a method of a benchmarking system benchmarking AI hardware using a synthetic AI model, in accordance with an embodiment of the present application.

FIG. 7 illustrates an exemplary computer system that facilitates a benchmarking system for AI hardware, in accordance with an embodiment of the present application.

FIG. 8 illustrates an exemplary apparatus that facilitates a benchmarking system for AI hardware, in accordance with an embodiment of the present application.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the embodiments described herein are not limited to the embodiments shown, but are to be accorded the widest scope consistent with the principles and features disclosed herein.

### Overview

The embodiments described herein solve the problem of efficiently benchmarking AI hardware by generating a synthetic AI model that represents the statistical characteristics of the workloads of a set of AI models corresponding to representative applications and their execution frequencies. The AI hardware can be a piece of hardware capable of efficiently processing AI-related operations, such as computing a layer of a neural network. The representative applications are the various applications that AI hardware, such as an AI accelerator, may run. Hence, the performance of the AI hardware is typically determined by benchmarking the AI hardware for the set of AI models. Benchmarking refers to the act of running a computer program, a set of programs, or other operations, to assess the relative performance of a software or hardware system. Benchmarking is typically performed by executing a number of standard tests and trials on the system.

An AI model can be any model that uses AI-based techniques (e.g., a neural network). An AI model can be a deep learning model that represents the architecture of a deep learning representation. For example, a neural network can be based on a collection of connected units or nodes where each connection (e.g., a simplified version of a synapse) between artificial neurons can transmit a signal from one to another. The artificial neuron that receives the signal can process it and then signal artificial neurons connected to it.

With existing technologies, the AI models (e.g., deep learning architectures) are typically derived from experimental designs. As a result, these AI models have become more application-specific. For example, these AI models can have functions specific to their intended goals, such as correct image processing or natural language processing (NLP). In the field of image processing, an AI model may only classify images, or in the field of NLP, an AI model may only differentiate linguistic expressions. This application-specific approach causes the AI models to have their own architecture and structure. Even though AI models can be application-specific, AI hardware is usually designed for a wide set of AI-based applications, which can be referred to as representative applications that represent the most typical use of AI.

Hence, to test the performance of the AI hardware for this set of applications, the corresponding benchmarking process can require execution of the set of AI models, which can be referred to as representative AI models, associated with the representative applications. However, running the representative AI models on the AI hardware and determining the respective performances may have a few drawbacks. For example, setting up (e.g., gathering inputs) and executing a respective one of the representative AI models can be time-consuming and labor-intensive. In addition, during the benchmarking process, the relative significance for a respective AI model (e.g., the respective execution frequencies) may not be apparent and may not be reflected during testing.

To solve this problem, embodiments described herein facilitate a benchmarking system that can generate a synthetic AI model, or an SAI model, (e.g., a synthetic neural network) that can efficiently evaluate the AI hardware. The SAI model can represent the computational workloads and execution frequencies of the representative AI models. This allows the system to benchmark the AI hardware by executing the SAI model instead of executing individual AI models on the AI hardware. Since the execution of the SAI model can correspond to the workload of the representative AI models and their respective execution frequencies, the system can benchmark the AI hardware by executing the SAI model and determine the performance of the AI hardware for the representative AI models.

During operation, the system can determine the representative AI models based on the representative application. For example, if image processing, natural language processing, and data generators are the representative applications, the system can obtain image classification and regressions models, voice recognition models, and generative models as representative AI models. The system then collects information associated with a respective layer of a respective AI model. Collected information can include one or more of: number of channels, number of filters, filter size, stride information, and padding information. The system can also determine the execution frequencies of a respective AI application (e.g., how frequently an application runs over a period of time). The system can use one or more framework interfaces, such as a graphics processing unit (GPU) application programming interfaces (API), to collect the information.

Based on the collected information and the execution frequencies, the system can determine the workload of a respective layer, and store the workload information in a workload table. The system then can cluster workloads of the layers (e.g., using k-means) based on the workload table. The system can also group the input sizes of the layers. The system can determine a representative workload for a respective cluster and a representative input size for a respective input group. The system then matches a respective representative workload to a corresponding representative input size such that the input size can generate the corresponding workload. The system may adjust an input size to match the workload. The system can generate an SAI model that includes a layer corresponding each cluster. The system then executes the SAI model to benchmark the AI hardware. Since the SAI model incorporates the statistical characteristics of the workload of all representative AI models, benchmarking using the SAI model allows the system to determine the performance of all representative AI models.

### Exemplary System

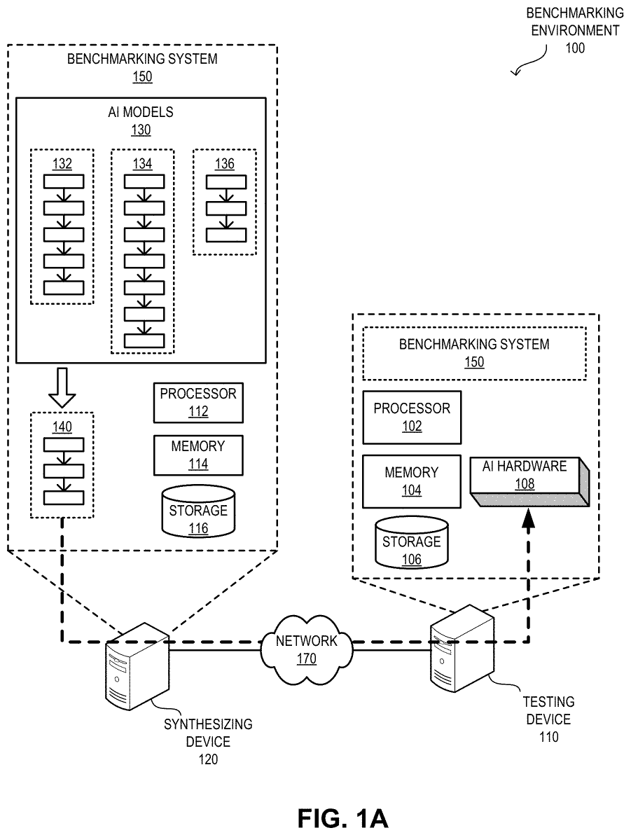

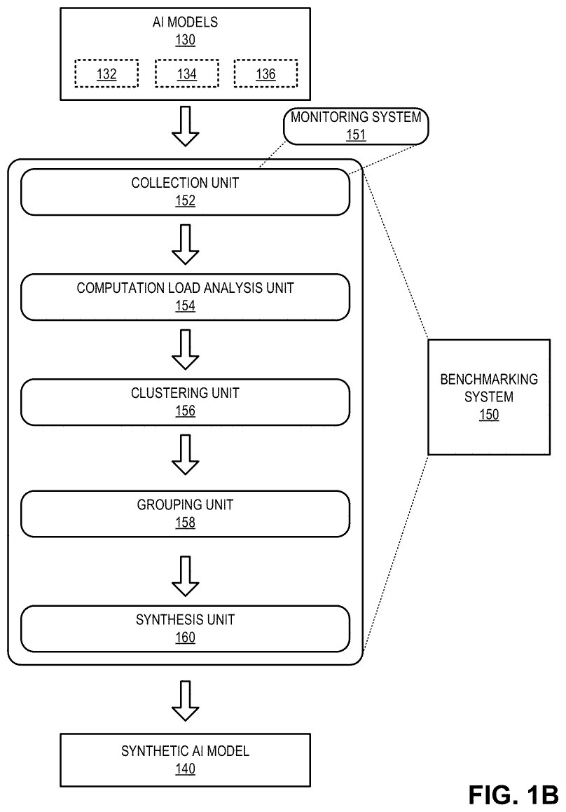

FIG. 1A illustrates an exemplary environment that facilitates generation of an SAI model for benchmarking AI hardware, in accordance with an embodiment of the present application. A benchmarking environment 100 can include a testing device 110 that includes AI hardware 108 and a synthesizing device 120. In this example, AI models 130 are the set of representative AI models corresponding to a set of representative applications. AI models 130 can include AI models 132, 134, and 136, forming the set of representative AI models. If image processing, NLP, and data generators are the representative applications, AI models 132, 134, and 136 can be image classification and regressions model, voice recognition model, and generative model, respectively.

Device 110 can be equipped with AI hardware 108, such as an AI accelerator, that can efficiently process the computations associated with AI models 130. Device 110 can also include a system processor 102, a system memory device 104, and a storage device 106. Device 110 can be used for testing the performance of AI hardware 108 for one or more of the representative applications. To evaluate the performance of AI hardware 108, device 110 can execute a number of standard tests and trials on AI hardware 108. For example, device 110 can execute AI models 130 on AI hardware 108 to evaluate their performance.

With existing technologies, AI models 130 can be typically derived from experimental designs. As a result, AI models 130 have become more application-specific. For example, each of AI models 130 can have functions specific to an intended goal. For example, AI model 132 can be structured for image processing, and AI model 134 can be structured for NLP. As a result, AI model 132 may only classify images, and AI model 134 may only differentiate linguistic expressions. This application-specific approach causes AI models 130 to have their own architecture and structure. Even though AI models 130 can be application-specific, AI hardware 108 can be designed to efficiently execute any combination of individual models in AI models 130.

Hence, to test the performance of AI hardware 108, a respective one of AI models 130 can be executed on AI hardware 108. However, running a respective one of AI models 130 on AI hardware 108 and determining the respective performances may have a few drawbacks. For example, setting up (e.g., gathering inputs) and executing a respective one of AI models 130 can be time-consuming and labor-intensive. In addition, during the benchmarking process, the relative significance for a respective AI model may not be apparent and may not be reflected during testing. For example, AI model 134 can typically be executed more times than AI model 136 over a period of time. As a result, the benchmarking process needs to accommodate the execution frequencies of AI models 130.

To solve this problem, a benchmarking system 150 can generate an SAI model 140, which can be a synthetic neural network, that can efficiently evaluate AI hardware 108. System 150 can operate on device 120, which can comprise a processor 112, a memory device 114, and a storage device 116. SAI model 140 can represent the computational workloads and execution frequencies of AI models 130. This allows system 150 to benchmark AI hardware 108 by executing SAI model 140 instead of executing individual models of AI models 130 on AI hardware 108. Since the execution of SAI model 140 can correspond to the workload of AI models 130 and their respective execution frequencies, system 150 can benchmark AI hardware 108 by executing SAI model 140 and determine the performance of AI hardware 108 for AI models 130.

During operation, system 150 can determine AI models 130 based on the representative applications. In some embodiments, system 150 can maintain a list of representative applications (e.g., in a local storage device) and their corresponding AI models. This list can be generated during the configuration of system 150 (e.g., by an administrator). Furthermore, AI models 130 can be loaded onto the memory of device 120 such that system 150 may access a respective one of AI models 130. This allows system 150 to collect information associated with a respective layer of AI models 132, 134, and 136. Collected information can include one or more of: number of channels, number of filters, filter size, stride information, and padding information.

System 150 can also determine the execution frequencies of a respective AI model in AI model 130. System 150 can use one or more techniques to collect the information. Examples of collection techniques include, but are not limited to, GPU API calls, TensorFlow calls, Caffe2, and MXNet. Based on the collected information and the execution frequencies, system 150 can determine the workload of a respective layer of a respective one of AI models 130. System 150 may calculate the computation load of a layer based on corresponding input parameters and the algorithm applied on it. System 150 can store the workload information in a workload table.

System 150 can cluster the workloads of the layers by applying a clustering technique to the workload table. For example, system 150 can use a k-means-based clustering technique in such a way that the value of k is configurable and may dictate the number of clusters. System 150 can also group the input sizes of the layers. In some embodiments, the number of input groups also corresponds to the value of k. Under such a scenario, the number of clusters corresponds to the number of input groups. System 150 can determine a representative workload for a respective cluster. To do so, system 150 can calculate a mean or a median of the workloads associated with the cluster (e.g., of the workloads of the layers in the cluster). Similarly, system 150 can also determine a representative input size for a respective input group.

System 150 then matches a respective representative workload to a corresponding representative input size such that the input size can generate the corresponding workload. System 150 may adjust an input size to match the workload. System 150 then generates SAI model 140 in such a way that a respective layer of SAI model 140 corresponds to a cluster and the input size for that layer is the adjusted input size matched to that cluster. System 150 may send SAI model 140 and its corresponding inputs to device 110 through file transfer (e.g., via a network 170, which can be a local or a wide area network). An instance of system 150 can operate on device 110 and execute SAI model 140 on AI hardware 108 for benchmarking. Since SAI model 140 incorporates the statistical characteristics of the workload of AI models 130, benchmarking using SAI model 140 allows system 150 to determine the performance of all of AI models 130 on AI hardware 108.

FIG. 1B illustrates an exemplary benchmarking system that generates a synthetic AI model for benchmarking AI hardware, in accordance with an embodiment of the present application. During operation, system 150 generates SAI model 140 that statistically matches the workload (i.e., computation load) of AI models 130. SAI model 140 can represent the statistical characteristics of the workload of each layer (e.g., convolution, pooling, normalization, etc.) of a respective one of AI models 130. Hence, evaluation results of SAI model 140 on AI hardware 108 can produce a statistically representative benchmark of AI models 130 running on AI hardware 108. This can improve the runtime of the benchmarking process.

System 150 can include a collection unit 152, a computation load analysis unit 154, a clustering unit 156, a grouping unit 158, and a synthesis unit 160. Collection unit 152 collects the layer information using a monitoring system 151, which can deploy one or more collection techniques, such as issuing API calls, for collecting information. Monitoring system 151 can obtain a number of channels, number of filters, filter size, stride information, and padding information associated with a respective layer of a respective one of AI models 130. It should be noted that if the number of representative AI models is large, monitoring system 151 may issue hundreds of thousands of API calls for different layers of the representative AI models.

Computation load analysis unit 154 then determines the computational load or the workload from the collected information. To do so, computation load analysis unit 154 can classify the layers. For example, the classes can correspond to convolution layer, pooling layer, and normalization layer. For each class, this computation load analysis unit 154 can calculate the workload of a layer based on the input parameters and algorithms applicable to the layer. In some embodiments, the workload of a layer can be calculated based on multiply-accumulate (MAC) time for the operations associated with the layer. Computation load analysis unit 154 then stores the computed workload in a workload table in association with the layer (e.g., using a layer identifier).

Clustering unit 156 can cluster the workloads of the layers in such a way that similar workloads are included in the same cluster. Clustering unit 156 can use a clustering technique, such as k-means-based clustering technique, to determine the clusters. In some embodiments, clustering unit 156 can use a predetermined or a configured value of k, which in turn, may dictate the number of clusters to be formed. Clustering unit 156 can determine the representative workload, or the center, for each cluster by calculating a mean or a median of the workloads associated with that cluster. Similarly, grouping unit 158 can group the similar input sizes of the layers into input groups. Grouping unit 158 can also calculate a mean or a median to determine the representative input size of a respective input group.

Synthesis unit 160 then synthesizes SAI model 140 based on the number of clusters. Typically, convolution is considered as the most important layer since the computational load of the convolution layers of an AI model represents most of the workload of the AI model. Hence, synthesis unit 160 can form SAI model 140 by clustering the workloads of the convolution layers. For example, if clustering unit 156 has formed n clusters of the workloads of the convolution layers, synthesis unit 160 can rank the representative workloads of these n clusters. Synthesis unit 160 can map each cluster to a corresponding input group in such a way that the representative input size of the input group can generate the representative workload of the cluster. To do so, synthesis unit 160 may adjust the input size of an input group. For example, synthesis unit 160 can adjust the number of channels, filter size, and stride for each layer of SAI model 140 to ensure that the workload of the layer corresponds to the workload of the associated cluster.

### Cluster and Group Formation

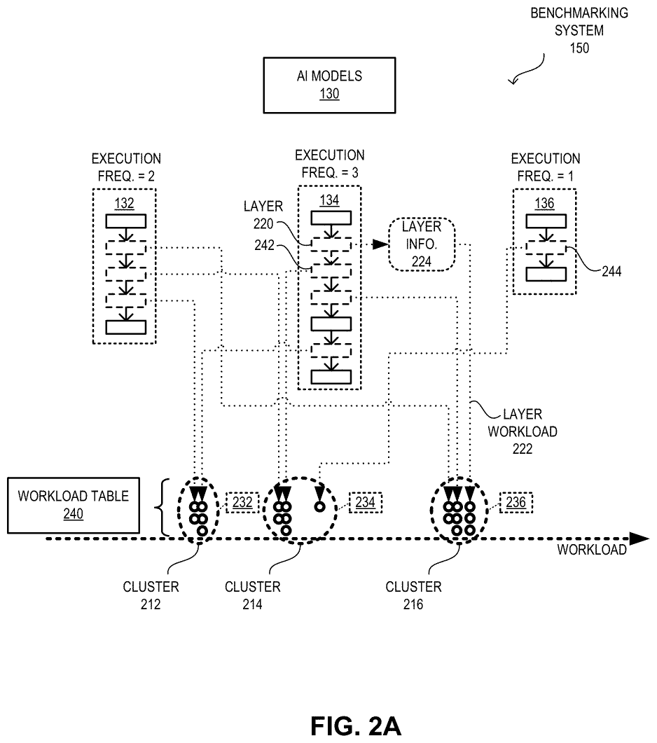

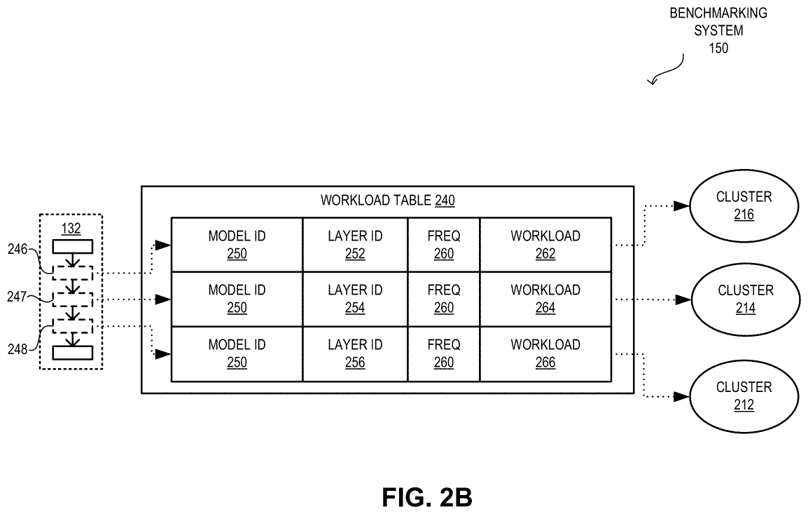

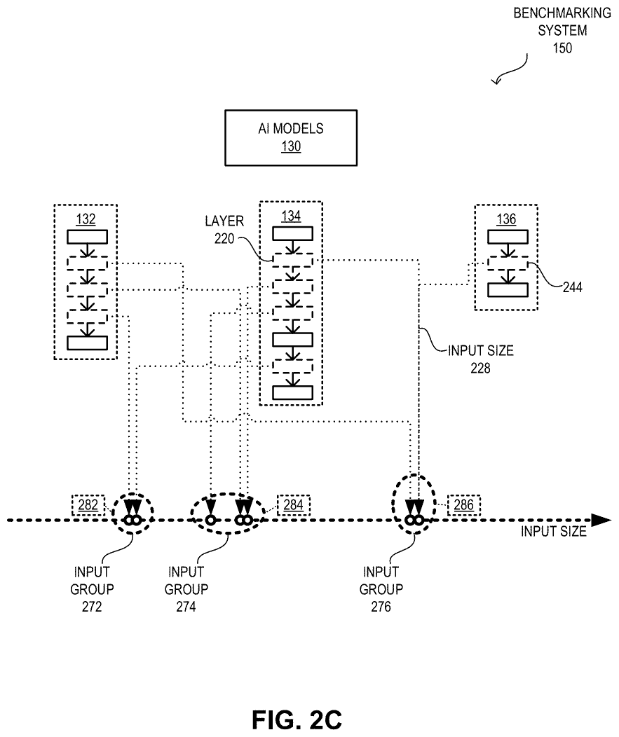

FIG. 2A illustrates an exemplary clustering of the workloads of the layers of representative AI models based on respective workloads for generating a synthetic AI model, in accordance with an embodiment of the present application. To cluster the layers based on their respective workloads, system 150 determines a class of layers of interest. In some embodiments, system 150 can select the convolution layers (denoted with dashed lines) for forming clusters since these layers are responsible for most of the computations of an AI model. In other words, if system 150 generates an SAI model that represents the statistical properties of the workloads of the convolution layers of AI models 130, that SAI model can be representative of the workloads of AI models 130.

System 150 then computes the workload associated with a respective layer of a respective one of AI models 130. For example, for a layer 220 of AI model 134, system 150 determines layer information 224, which can include number of filters, filter size, stride information, and padding information. In some embodiments, system 150 uses layer information 224 to determine the MAC operations associated with layer 220 and compute MAC time that indicates the time to execute the determined MAC operations. System 150 can use the computed MAC time as workload 222 for that layer. Suppose that the execution frequency of AI model 134 is 3. System 150 can then calculate workload 222 three times, and consider each of them as a workload of an individual and separate layer. Alternatively, system 150 can store workload 222 in association with the execution frequency of AI model 134. This allows system 150 to accommodate execution frequencies of AI models 130.

System 150 can repeat this process for a respective selected layer of a respective one of AI models 130. In some embodiments, system 150 can store the computed workloads in a workload table 240. System 150 then parses workload table 240 to cluster the workloads into a set of clusters 212, 214, and 216. System 150 can form a cluster using any clustering technique. System 150 can determine the number of clusters based on a clustering parameter. The parameter can be based on how the workloads are distributed (e.g., based on a range of workloads that can be included in a cluster or a diameter of a cluster) or a predetermined number of clusters. Based on the clustering parameter, in the example in FIG. 2A, clusters 212, 214, and 216 can include five, six, and eight workloads, respectively.

System 150 then determines a representative workload for a respective cluster. In the example in FIG. 2A, cluster 216 can include eight workloads corresponding to different layers and their respective execution frequencies. System 150 can calculate a representative workload 236 for cluster 216 by calculating the average (or the median) of the eight workloads in cluster 216. In the same way, system 150 can calculate representative workload 232 for cluster 212 based on the five workloads in cluster 212 and representative workload 234 for cluster 214 based on the six workloads in cluster 214. Since the workloads in a cluster also incorporate the execution frequencies, the representative weight for a cluster can be closer to the workload of a layer with a high execution frequency. For example, since the execution frequency of layer 242 is three and the execution frequency of layer 244 is one, representative workload 234 is closer to the workload of layer 242.

FIG. 2B illustrates an exemplary workload table for facilitating the clustering of the workloads, in accordance with an embodiment of the present application. Workload table 240 can include a respective workload computed by system 150. Workload table 240 can map a respective workload to a corresponding AI model identifier, a layer identifier of the layer corresponding to the workload, and an execution frequency of the AI model. Suppose that AI model 132 includes layers 246, 247, and 248, which can be convolution layers. AI model 132 can be identified by a model identifier 250 and layers 246, 247, and 248 can be identified by layer identifiers 252, 254, and 256, respectively. AI model 132 can have an execution frequency 260. In the example in FIG. 2A, the value of execution frequency 260 is 2.

During operation, system 150 computes workload 262 for layer 246. System 150 can generate an entry in workload table for workload 262, which maps workload 262 to AI model identifier 250, layer identifier 252, and execution frequency 260. This allows system 150 to compute workload 262 once instead of the number of times specified by execution frequency 260. When system 150 computes the representative workload, system 150 can consider (workload 262*execution frequency 260) for the computation. In the same way, system 150 computes workloads 264 and 266 for layers 247 and 248, respectively, of AI model 132. System 150 can store workloads 264 and 266 in workload table 240 in association with the corresponding AI model identifier 250, layer identifiers 254 and 256, respectively, and execution frequency 260.

FIG. 2C illustrates an exemplary grouping of input sizes of the layers of representative AI models for generating a synthetic AI model, in accordance with an embodiment of the present application. System 150 can obtain the input size of a respective layer of a respective one of AI models 130. For example, for layer 220 of AI model 134, system 150 determines input size 228, which can include number of filters, filter size, stride information, and padding information. Similarly, system 150 determines the input size of a respective selected layer (e.g., the convolution layer) of a respective one of AI models 130. System 150 then groups the input sizes into a set of input groups 272, 274, and 276. System 150 can form an input group using any grouping technique.

System 150 then determines a representative input size for a respective input group. In the example in FIG. 2C, cluster 216 can include two input sizes corresponding to different layers. Since layers 220 and 244 can have the same input size 228, system 150 may consider input size 228 once or twice in input group 276 depending on a calculation policy. System 150 can calculate a representative input size 286 for input group 276 by calculating the average (or the median) of the two (or three depending on the calculation policy) input sizes in input group 276. In the same way, system 150 can calculate representative input size 282 for input group 272 based on the two input sizes in input group 272 and representative input group 284 for input group 274 based on the three input sizes in input group 274.

### Synthesis

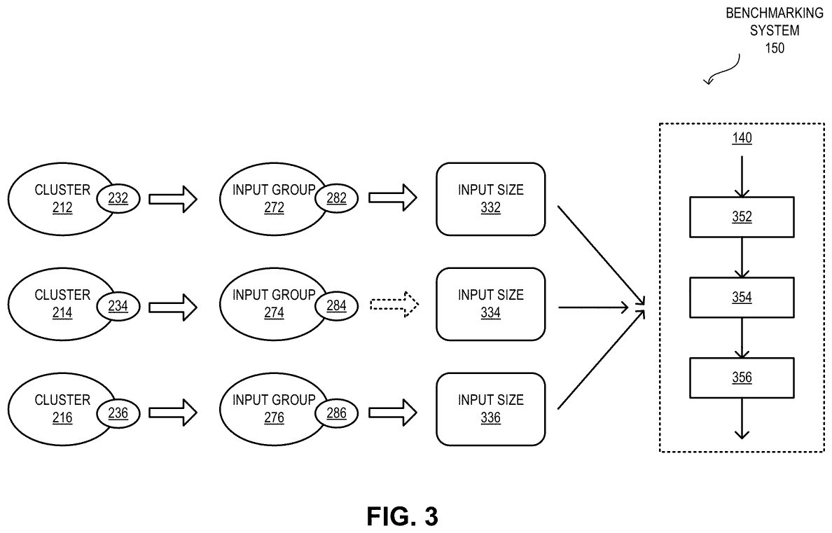

System 150 uses clusters 212, 214, and 216 to generate the layers of SAI model 140. System 150 further determines the input size for a respective layer corresponding to the representative workload of each of clusters 212, 214, and 216. To do so, system 150 matches clusters 212, 214, and 216 to input groups 272, 274, and 276. FIG. 3 illustrates an exemplary matching of clusters and corresponding input sizes, in accordance with an embodiment of the present application. During operation, system 150 determines, for each of representative workloads 232, 234, and 236, the input size that can generate the representative workload for a corresponding layer.

To do so, system 150 can match representative input sizes 282, 284, and 286, respectively, to representative workloads 232, 234, and 236. If a representative input size, used as an input to a layer of an AI model, doesn't generate a corresponding representative workload, system 150 may adjust the input size. Suppose that input sizes 282 and 286, used as inputs to layers of an AI model, can generate workloads 232 and 236, respectively. Hence, system 150 can mark input sizes 282 and 286 as input sizes 332 and 336 for the layers of SAI model 140 corresponding to clusters 212 and 216.

However, if input size 284, used as an input to a layer of an AI model, doesn't generate workload 234, system 150 may adjust input size 284. The adjustment process can include a heuristic, which incorporates input size 284 as an initial input, for finding an input size corresponding to workload 234. This heuristic can be a meta-heuristic optimization technique that may search for an input size corresponding to workload 234 using input size 334 as an initial value. Based on the adjustment, system 150 can determine an adjusted input size 334, which can generate workload 234 if used as an input to a layer of an AI model. In this way, system 150 determines input size 334 for the layer of SAI model 140 corresponding to cluster 214.

System 150 considers channel number, filter size, and stride in input sizes 282, 284, and 286 for the matching and adjustment process. For example, system 150 determines whether channel number, filter size, and stride in input size 282 is a match for workload 232. Furthermore, system 150 adjusts channel number, filter size, and stride in input size 284 to generate input size 334 corresponding to workload 234. System 150 then builds SAI model 140, which comprises three layers 352, 354, and 356 corresponding to clusters 212, 214, and 216, respectively.

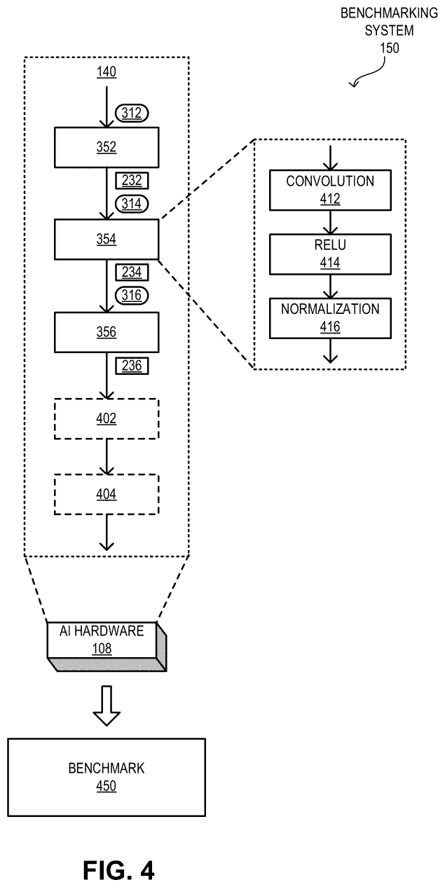

FIG. 4 illustrates an exemplary synthetic AI model representing a set of AI models corresponding to representative applications, in accordance with an embodiment of the present application. Upon determining input sizes 312, 314, and 316, system 150 builds SAI model 140 with layers 352, 354, and 356 corresponding to clusters 212, 214, and 216, respectively. System 150 determines layers 352, 354, and 356 in such a way that these layers use input sizes 312, 314, and 316 to generate workloads 232, 234, and 236, respectively. Since the convolution layers of AI models 130 represent most of the workloads, system 150 can generate layers 352, 354, and 356 as convolution layers.

For example, suppose that SAI model 140 generates a synthetic image based on an input image. Suppose that the input image size is 224×224×3. The output image dimension can be calculated as (input image size−filter size)/stride+1. Suppose that workload 232 is 36602000 (e.g., a MAC value of 36602000). System 150 then determines channel number as 100, filter size as 11×11, and stride as 4 for input size 332. This leads to an output image size of 55. This can generate a workload of approximately 36602500, which is a close approximation of workload 232, for layer 352. In some embodiments, system 150 considers two values to be close approximations of each other if they are within a threshold value of each other.

In the same way, workload 234 can be 1351000. System 150 then determines channel number as 80, filter size as 5×5, and stride as 2 for input size 334. This leads to an output image size of 26. This can generate a workload of approximately 1352000, which is a close approximation of workload 234, for layer 354. Similarly, workload 236 can be 228000. System 150 then determines channel number as 150, filter size as 3×3, and stride as 2 for input size 336. This leads to an output image size of 13. This can generate a workload of approximately 228150, which is a close approximation of workload 236, for layer 356.

Furthermore, to ensure transition among layers 352, 354, and 356, system 150 can incorporate a rectified linear unit (ReLU) layer and a normalization layer in a respective one of layers 352, 354, and 356. As a result, a respective one of these layers includes convolution, ReLU, and normalization layers. For example, layer 354 can include convolution layer 412, ReLU layer 414, and normalization layer 416. System 150 then appends a fully connected layer 402 and a softmax layer 404 to SAI model 140. In this way, system 150 completes the construction of SAI model 140.

System 150 then determines the performance of AI hardware 108 to generate benchmark 450. Since workloads 232, 234, and 236 represent the statistical properties of the selected layers of AI models 130, benchmarking AI hardware 108 using SAI model 140 can be considered as similar to benchmarking AI hardware 108 using a respective one of AI models 130 on AI hardware 108 at corresponding execution frequencies. Therefore, system 150 can efficiently generate benchmark 450 for AI hardware 108 by executing SAI model 140, thereby avoiding the drawbacks of benchmarking AI hardware 108 using a respective one of AI models 130.

### Operations

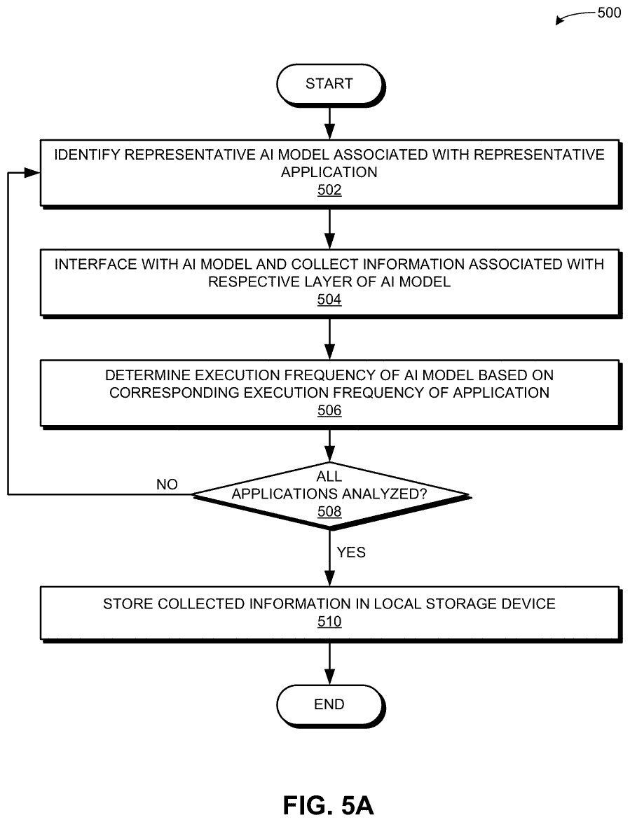

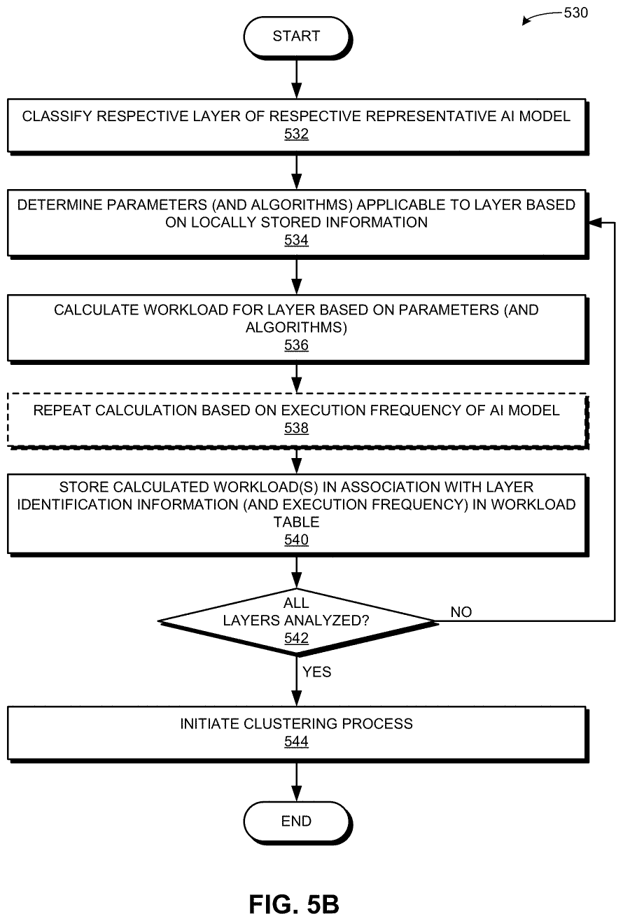

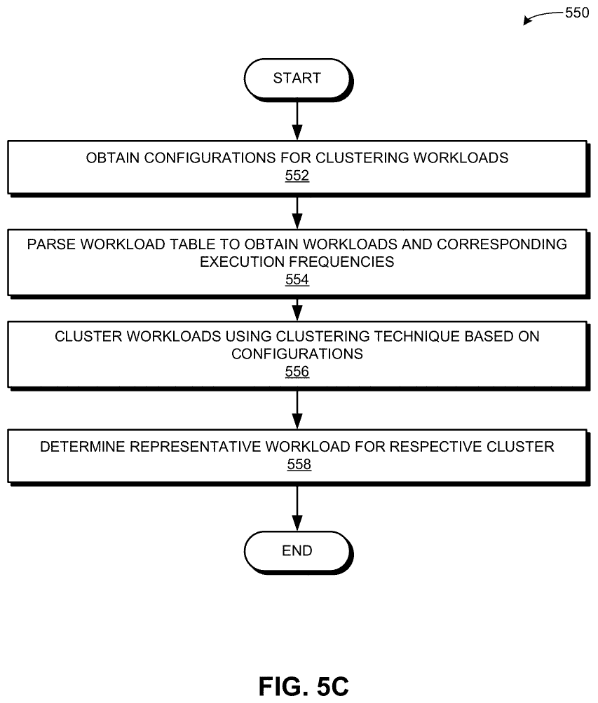

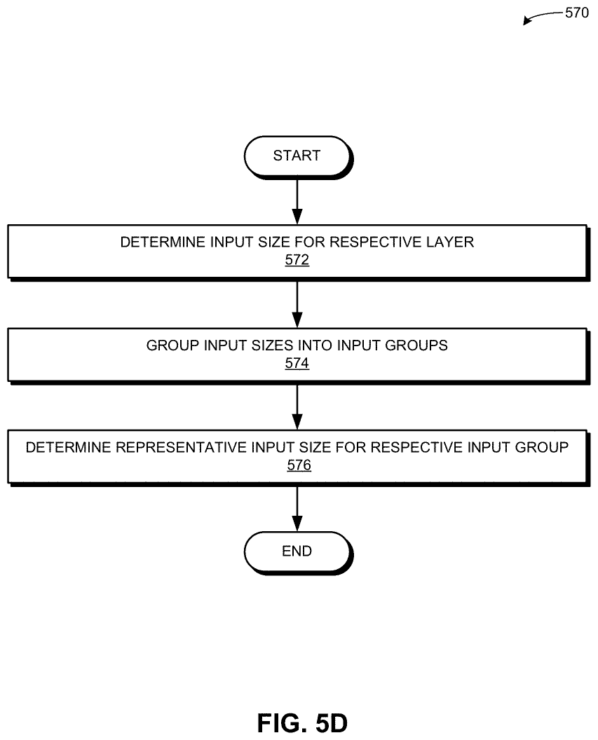

FIG. 5A presents a flowchart 500 illustrating a method of a benchmarking system collecting layer information of representative AI models, in accordance with an embodiment of the present application. During operation, the system identifies a representative AI application associated with a representative application (operation 502). The system can interface with the AI model and collect information associated with a respective layer of the AI model (operation 504). The system determines an execution frequency of the AI model based on the corresponding execution frequency of the application (operation 506). The system then checks whether it has analyzed all representative applications (operation 508). If it hasn't analyzed all representative applications, the system continues to identify a representative AI application associated with the next representative application (operation 502). Upon analyzing all representative applications, the system stores the collected information in a local storage device (operation 510).

FIG. 5B presents a flowchart 530 illustrating a method of a benchmarking system performing computation load analysis, in accordance with an embodiment of the present application. During operation, the system classifies a respective layer of a respective representative AI model (operation 532) and determines parameters (and algorithms) applicable to a layer based on the locally stored information (operation 534). Such parameters can include number of filters, filter size, stride information, and padding information associated with the layer. The system then calculates the workload for the layer based on the parameters (and algorithms) (operation 536)

The system can, optionally, repeat the calculation based on the execution frequency of the AI model (operation 538). Alternatively, the system can store the workload in association with the execution frequency of the AI model. The system then stores the calculated workload(s) in association with the layer identification information (and the execution frequency) in a workload table (operation 540). The system checks whether it has analyzed all layers (operation 542). If it hasn't analyzed all layers, the system continues to determine parameters (and algorithms) applicable to the next layer based on the locally stored information (operation 534). Upon analyzing all layers, the system initiates the clustering process (operation 544).

FIG. 5C presents a flowchart 550 illustrating a method of a benchmarking system clustering the layers of representative AI models based on respective workloads, in accordance with an embodiment of the present application. During operation, the system obtains the configurations for clustering the workloads (e.g., the value of k) (operation 552) and parses the workload table to obtain the workloads and corresponding execution frequencies (operation 554). The system clusters the workloads using a clustering technique (e.g., using k-means-based clustering) based on the configurations (operation 556). The system then determines the representative workload for a respective cluster (operation 558).

FIG. 5D presents a flowchart 570 illustrating a method of a benchmarking system grouping input sizes of the layers of representative AI models, in accordance with an embodiment of the present application. During operation, the system determines the input size for a respective layer (operation 572). The system groups the input sizes into input groups (operation 574). In some embodiments, the number of input groups can correspond to the number of clusters. The system then determines the representative input size for a respective input group (operation 576).

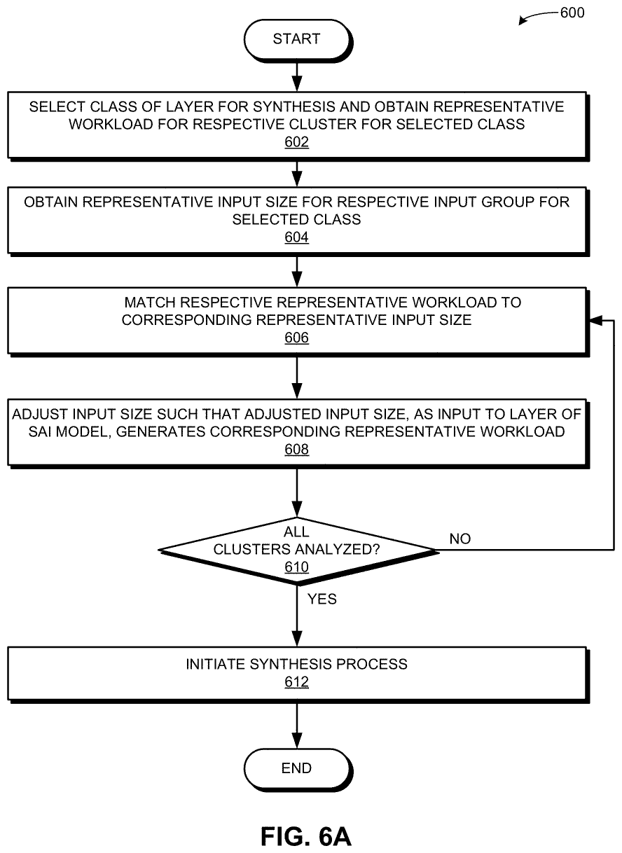

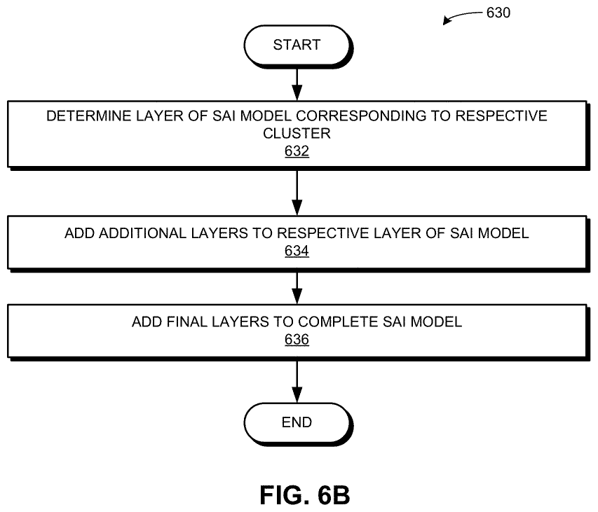

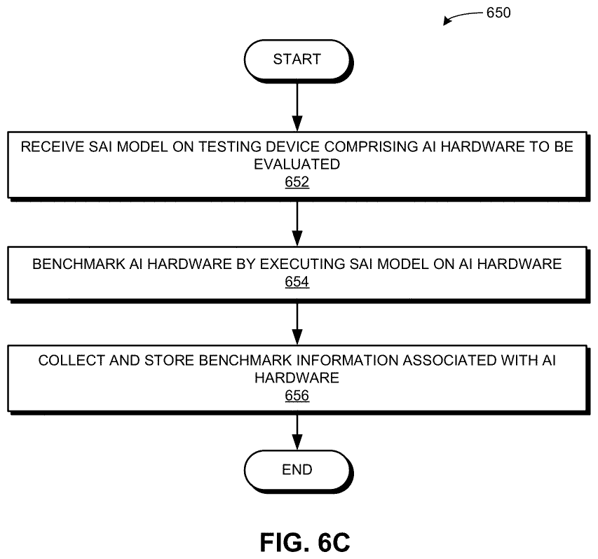

FIG. 6A presents a flowchart 600 illustrating a method of a benchmarking system matching clusters and corresponding input sizes, in accordance with an embodiment of the present application. During operation, the system selects a class of layer (e.g., the convolution layer) for synthesis and obtains the representative workload of a respective cluster for the selected class (operation 602). The system obtains the representative input size for a respective input group for the selected class (operation 604). The system then matches a respective representative workload to a corresponding representative input size (operation 606).

The system can also adjust an input size such that the adjusted input size, as an input to a layer of an SAI model, generates a corresponding representative workload (operation 608). The system checks whether it has analyzed all clusters (operation 610). If it hasn't analyzed all clusters, the system continues to matches a respective representative workload to a corresponding representative input size (operation 606). Upon analyzing all clusters, the system initiates the synthesis process (operation 612).

FIG. 6B presents a flowchart 630 illustrating a method of a benchmarking system generating a synthetic AI model representing a set of AI models, in accordance with an embodiment of the present application. During operation, the system determines a layer of the SAI model corresponding to a respective cluster (operation 632). This layer can correspond to a convolution layer and the SAI model can be a synthetic neural network. The system can add additional layers, such as a ReLU layer and a normalization layer, to a respective layer of the SAI model (operation 634). The system can add final layers, which can include a fully connected layer and a softmax layer, to complete the SAI model (operation 636).

FIG. 6C presents a flowchart 650 illustrating a method of a benchmarking system benchmarking AI hardware using a synthetic AI model, in accordance with an embodiment of the present application. During operation, the system receives the SAI model on the testing device comprising the AI hardware to be evaluated (operation 652) and benchmarks the AI hardware by executing the SAI model on the AI hardware (operation 654). The system then collects and stores benchmark information associated with the AI hardware (operation 656).

### Exemplary Computer System and Apparatus

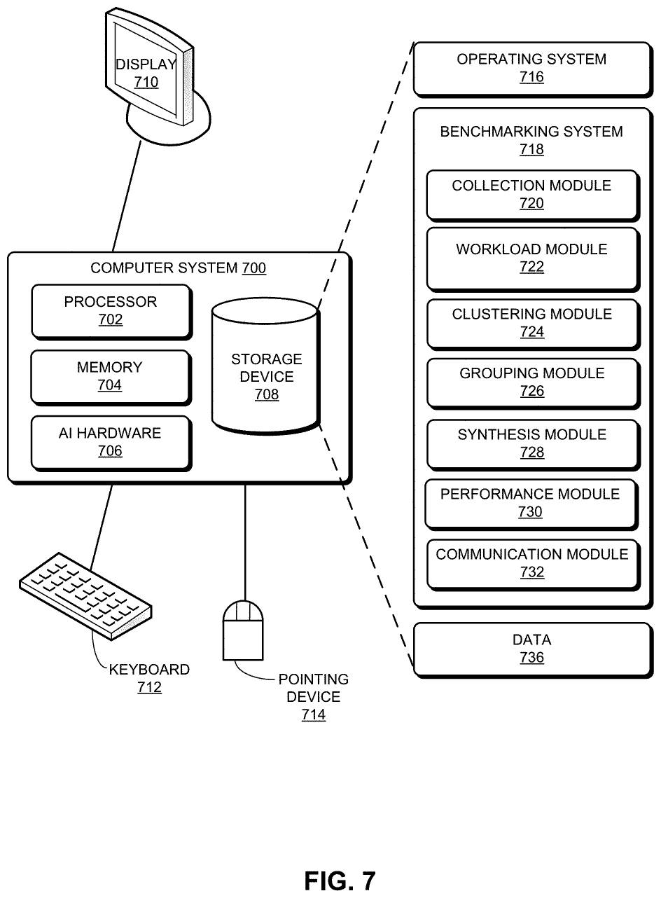

FIG. 7 illustrates an exemplary computer system that facilitates a benchmarking system for AI hardware, in accordance with an embodiment of the present application. Computer system 700 includes a processor 702, a memory device 704, and a storage device 708. Memory device 704 can include a volatile memory device (e.g., a dual in-line memory module (DIMM)). Furthermore, computer system 700 can be coupled to a display device 710, a keyboard 712, and a pointing device 714. Storage device 708 can store an operating system 716, a benchmarking system 718, and data 736. In some embodiments, computer system 700 can also include AI hardware 706 comprising one or more AI accelerators, as described in conjunction with FIG. 1A. Benchmarking system 718 can incorporate the operations of system 150.

Benchmarking system 718 can include instructions, which when executed by computer system 700 can cause computer system 700 to perform methods and/or processes described in this disclosure. Specifically, benchmarking system 718 can include instructions for collecting information associated with a respective layer of a one respective of representative AI models (collection module 720). Benchmarking system 718 can also include instructions for calculating the workload (i.e., the computational load) for a respective layer of a respective one of representative AI models (workload module 722). Furthermore, benchmarking system 718 includes instructions for clustering the workloads and determining a representative workload for a respective cluster (clustering module 724).

In addition, benchmarking system 718 includes instructions for grouping input sizes of a respective layer of a respective one of representative AI models into input groups (grouping module 726). Benchmarking system 718 can further include instructions for determining a representative input size for a respective input group (grouping module 726). Benchmarking system 718 can also include instructions for generating an input size corresponding to a respective representative workload based on matching and adjusting, as described in conjunction with FIG. 3 (synthesis module 728). Benchmarking system 718 can include instructions for generating an SAI model based on the clusters and the input sizes (synthesis module 728).

Benchmarking system 718 can also include instructions for benchmarking AI hardware by executing the SAI model (performance module 730). Benchmarking system 718 may further include instructions for sending and receiving messages (communication module 732). Data 736 can include any data that can facilitate the operations of system 150. Data 736 may include one or more of: layer information, a workload table, cluster information, and input group information.

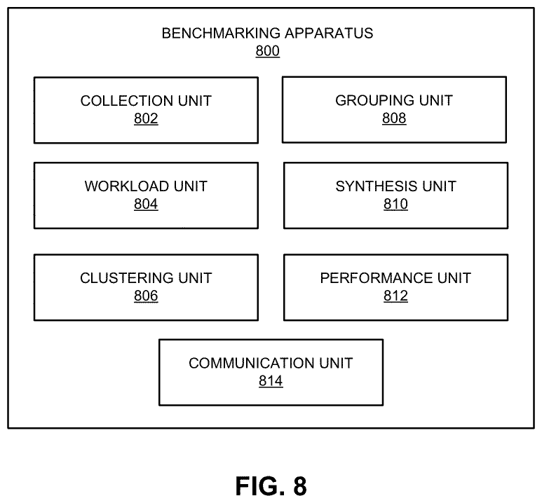

FIG. 8 illustrates an exemplary apparatus that facilitates a benchmarking system for AI hardware, in accordance with an embodiment of the present application. Benchmarking apparatus 800 can comprise a plurality of units or apparatuses, which may communicate with one another via a wired, wireless, quantum light, or electrical communication channel. Apparatus 800 may be realized using one or more integrated circuits, and may include fewer or more units or apparatuses than those shown in FIG. 8. Further, apparatus 800 may be integrated in a computer system, or realized as a separate device that is capable of communicating with other computer systems and/or devices. Specifically, apparatus 800 can comprise units 802-814, which perform functions or operations similar to modules 720-732 of computer system 700 of FIG. 7, including: a collection unit 802; a workload unit 804; a clustering unit 806; a grouping unit 808; a synthesis unit 810; a performance unit 812; and a communication unit 814.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing embodiments described herein have been presented for purposes of illustration and description only. They are not intended to be exhaustive or to limit the embodiments described herein to the forms disclosed. Accordingly, many modifications and variations will be apparent to practitioners skilled in the art. Additionally, the above disclosure is not intended to limit the embodiments described herein. The scope of the embodiments described herein is defined by the appended claims.

What is claimed is:

1. A computer-implemented method, the method comprising:
determining a set of artificial intelligence (AI) models that are representative of applications that run on a piece of hardware, wherein the piece of hardware is configured to process AI-related operations;
determining workloads of the set of AI models based on layer information associated with a respective layer of a respective AI model in the set of AI models;
forming a set of workload clusters from the determined workloads; and
determining, based on the set of workload clusters, a synthetic AI model configured to generate a workload that represents statistical properties of the determined workload.

2. The method of claim 1, further comprising obtaining the layer information using a collection technique, wherein the collection technique includes one or more of: graphics processing unit (GPU) application programming interface (API) calls, TensorFlow calls, Caffe2, and MXNet.

3. The method of claim 1, further comprising:
generating a set of computational layers such that a computational layer corresponds to a respective workload cluster in the set of workload clusters; and
combining the set of computational layers to form the synthetic AI model.

4. The method of claim 3, further comprising:
determining a representative workload of the workload cluster; and
determining an input size that corresponds to the representative workload, wherein the input size used in the layer of the synthetic AI model generates the representative workload.

5. The method of claim 4, wherein determining the input size further comprises:
determining a set of input sizes corresponding to layers of the set of AI models;
forming a set of input groups of the set of input sizes;
determining a representative input size for a respective input group in the set of input groups; and
adjusting the representative input size for the representative workload to determine the input size.

6. The method of claim 3, further comprising adding a rectified linear unit (ReLU) layer and a normalization layer to a respective computational layer of the set of computational layers, wherein the computational layer is a convolution layer.

7. The method of claim 3, wherein forming the synthetic AI model further comprises adding a fully connected layer and a softmax layer to the synthetic AI model.

8. The method of claim 1, wherein the layer information includes number of filters, filter size, stride information, and padding information associated with the layer of the AI model.

9. The method of claim 1, wherein a respective workload of a workload cluster in the set of workload clusters incorporates an execution frequency of an AI model associated with the workload.

10. The method of claim 1, further comprising evaluating performance of the piece of hardware by executing the synthetic AI model on the piece of hardware.

11. A non-transitory computer-readable storage medium storing instructions that when executed by a computer cause the computer to perform a method, the method comprising:
determining a set of artificial intelligence (AI) models that are representative of applications that run on a piece of hardware, wherein the piece of hardware is configured to process AI-related operations;
determining workloads of the set of AI models based on layer information associated with a respective layer of a respective AI model in the set of AI models;
forming a set of workload clusters from the determined workloads; and
determining, based on the set of workload clusters, a synthetic AI model configured to generate a workload that represents statistical properties of the determined workload.

12. The non-transitory computer-readable storage medium of claim 11, wherein the method further comprises obtaining the layer information using a collection technique, wherein the collection technique includes one or more of: graphics processing unit (GPU) application programming interface (API) calls, TensorFlow calls, Caffe2, and MXNet.

13. The non-transitory computer-readable storage medium of claim 11, wherein the method further comprises:
generating a set of computational layers such that a computational layer corresponds to a respective workload cluster in the set of workload clusters; and
combining the set of computational layers to form the synthetic AI model.

14. The non-transitory computer-readable storage medium of claim 13, wherein the method further comprises:
determining a representative workload of the workload cluster; and
determining an input size that corresponds to the representative workload, wherein the input size used in the layer of the synthetic AI model generates the representative workload.

15. The non-transitory computer-readable storage medium of claim 14, wherein determining the input size further comprises:
determining a set of input sizes corresponding to layers of the set of AI models;
forming a set of input groups of the set of input sizes;
determining a representative input size for a respective input group in the set of input groups; and
adjusting the representative input size for the representative workload to determine the input size.

16. The non-transitory computer-readable storage medium of claim 13, wherein the method further comprises adding a rectified linear unit (ReLU) layer and a normalization layer to a respective computational layer of the set of computational layers, wherein the computational layer is a convolution layer.

17. The non-transitory computer-readable storage medium of claim 13, wherein forming the synthetic AI model further comprises adding a fully connected layer and a softmax layer to the synthetic AI model.

18. The non-transitory computer-readable storage medium of claim 11, wherein the layer information includes number of filters, filter size, stride information, and padding information associated with the layer of the AI model.

19. The non-transitory computer-readable storage medium of claim 11, wherein a respective workload of a workload cluster in the set of workload clusters incorporates an execution frequency of an AI model associated with the workload.

20. The non-transitory computer-readable storage medium of claim 11, wherein the method further comprises evaluating performance of the piece of hardware by executing the synthetic AI model on the piece of hardware.
